(19) United States
(12) Patent Application Publication
(10) Pub. No.: US 2013/0160024 A1
(43) Pub. Date: Jun. 20, 2013

(54) Dynamic Load Balancing for Complex Event Processing

(71) Applicants: Gregory Shtilman, Redondo Beach, CA (US); Dilip Sarmah, Fremont, CA (US); Mark Theiding, Alameda, CA (US)

(72) Inventors: Gregory Shtilman, Redondo Beach, CA (US); Dilip Sarmah, Fremont, CA (US); Mark Theiding, Alameda, CA (US)

(73) Assignee: SYBASE, INC., Dublin, CA (US)

(21) Appl. No.: 13/331,830

(22) Filed: Dec. 20, 2011

(51) Int. Cl. G06F 9/46

(52) U.S. Cl. 718/105

(57) ABSTRACT

Disclosed herein are methods, systems, and computer readable storage media for performing load balancing actions in a complex event processing system. Static statistics of a complex event processing node, dynamic statistics of the complex event processing node, and project statistics for projects executing on the complex event processing node are aggregated. A determination is made as to whether the aggregated statistics satisfy a condition. A load balancing action may be performed, based on the determination.

### BACKGROUND

1. Field

The invention relates generally to complex event processing.

2. Background Art

Traditional data analysis often includes executing queries against static or dynamic data stored in databases. Such databases may not support the requirements of modern businesses to analyze and process high volumes of constantly changing data. Complex event processing systems receive streams of input data from various sources. Users of such systems may specify queries that may be run against the streams of data to produce analysis and other useful information based on the input data.

### BRIEF SUMMARY

Embodiments disclosed herein include systems, methods and computer-readable media for supporting load balancing in a complex event processing system. A complex event processing node may be provided with a load balancing agent. The load balancing agent may be configured to aggregate static characteristics of a complex event processing node. The load balancing agent may also aggregate dynamic statistics for the complex event processing node, and may also aggregate project statistics for projects executing on the complex event processing node. The load balancing agent is configured to determine if the aggregated statistics satisfy a condition. Based on the determination, the load balancing agent may cause a load balancing action to be performed.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to a person skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the invention and, together with the description, further serve to explain the principles of the invention and to enable a person skilled in the relevant art to make and use the invention.

FIG. 1 is a diagram of an exemplary complex event processing cluster node.

FIG. 2 is a diagram of an exemplary complex event processing system.

FIG. 3 is a flow diagram of a method in accordance with an embodiment.

FIG. 4 is an example computer system in which embodiments of the invention can be implemented.

The invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

### Introduction

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

Complex event processing systems are used in modern businesses to analyze streams of data received from multiple external sources of data. For example, complex event processing systems are used by financial services firms to analyze data related to potential and current investments. CEP systems may also be used to monitor the health of computer networks. Other external sources of data may include, but are not limited to, sensor devices, messaging systems, and radio frequency identification (RFID) readers.

In an embodiment, at least some data in a CEP system is received via messages sent by outside systems and sources, such as financial systems or sensors. CEP systems may process hundreds of thousands of messages per second (or more), depending on the implementation of the system. CEP systems differ from traditional database systems in the speed at which queries are executed against constantly changing input data. CEP systems are typically characterized by very low latency requirements, typically measured in milliseconds.

Complex event processing systems may include a large number of individual computing systems or nodes. Such CEP systems may be known as a CEP cluster. CEP clusters may be very dynamic. Projects executing on CEP clusters may consume hardware resources of individual systems depending on message throughput, and the complexity of the project. Users may deploy new projects in the cluster or terminate projects at any point.

Complex Event Processing Cluster Node

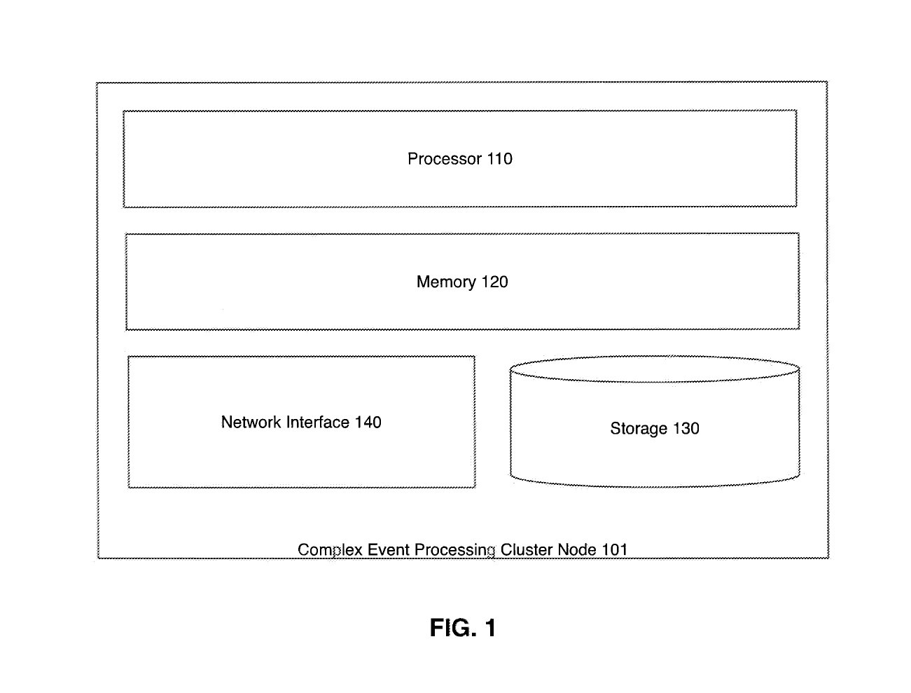

FIG. 1 is a diagram of a complex event processing cluster node 101, in accordance with an embodiment. CEP cluster node 101 includes processor 110, memory 120, storage 130, and network interface 140.

Processor 110 may be a central processing unit, as would be known to one of ordinary skill in the art. Processor 110 may be, in some embodiments, a general purpose or special purpose processor. CEP cluster node 101 may include one or more processors 110, which may operate in parallel. Each processor 110 in a CEP cluster node 101 may have a specific clock rate. Processor 110 may process messages and execute projects of queries on data received by CEP cluster node 101.

Memory 120 of CEP cluster node 101 may be, in some embodiments, random access memory (RAM). CEP cluster node 101 may contain a specific amount of memory 120, as specified by a user or manufacturer of CEP cluster node 101.

CEP cluster node 101 may include storage 130. Storage 130 may be persistent storage used for projects in a CEP environment, and may be hard disk drive storage, solid state storage, flash storage, or other type of persistent storage. Each CEP cluster node 101 may contain a specified storage capacity for storage 130.

CEP cluster node 101 further includes network interface 140. Network interface 140 may be, in some embodiments, an Ethernet network interface. Network interface 140 may connect CEP cluster node 101 to a local area network or wide area network, such as the Internet.

Complex Event Processing System

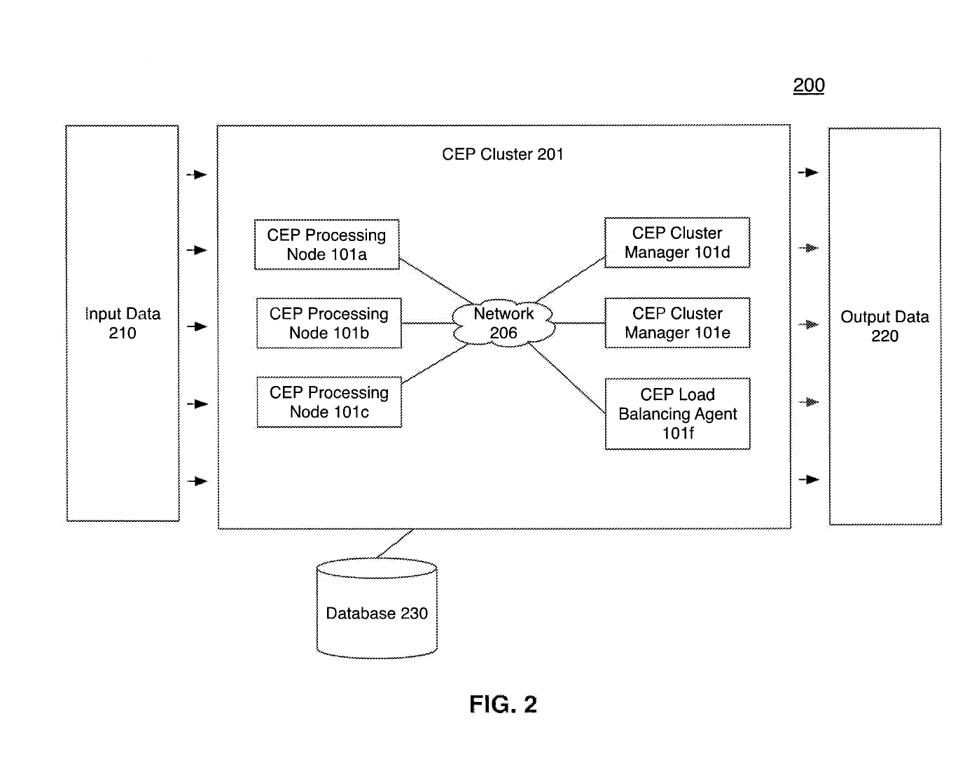

FIG. 2 is a diagram of a complex event processing system 200, in accordance with an embodiment. CEP system 200 includes CEP cluster 201, input data 210, and output data 220. CEP system 200 further includes database 230. Input data 210 may include, for example and without limitation, data from real-time data feed devices, messaging systems, RFID readers, and other data sources.

CEP cluster 201 may include one or more CEP cluster nodes 101a-101f. CEP nodes 101a-101f may be connected by way of a network 206, which may be a wired or wireless local area network or wide area network. Each CEP cluster node 101 in CEP cluster 201 may be configured as a CEP processing node, a CEP cluster manager, or a CEP load balancing agent. For example, in CEP cluster 201, CEP cluster nodes 101a-101c may be configured as CEP processing nodes.

CEP cluster 201 may be configured to perform distributed statement processing on one or more processes, parallel statement processing, clustering, and automatic failover from one CEP processing node to another. Further, CEP cluster 201 may be configured to perform statement processing on one or more. CEP processing nodes 101a-101c. CEP cluster managers 101d and 101e of CEP cluster 201 may be configured to control which CEP processing node 101a-101c performs statement processing.

CEP processing nodes 101a-101c process data streams that include real-time data, such as the data described above, against instructions written in, for example, Continuous Computation Language (CCL). CEP processing nodes 101a-101c receive real-time input data 210. CEP processing nodes 101a-101c may process these data streams according to CCL logic stored by each processing node. Each CEP processing node 101a-101c may execute one or more projects or applications. As described above, CEP processing nodes 101a-101c may execute on a single processor or on a distributed system that includes multiple processors. Such distributed systems may include multiple machines, each of which includes one or more processors. Each CEP processing node 101a-101c may also receive and send data to database 230.

Each CEP processing node 101a-101c may also include storage, such as persistent storage, used by one or more CEP projects executing on the CEP processing node. A project may be configured to use storage to write data to a disk for failure recovery or other reasons, and may incur a performance penalty for doing so. Persistent storage may use a network or other shared storage. Shared storage allows for recovery of persistent data during failover of one project from one CEP processing node to another.

Each CEP processing node 101a-101c may also include one or more input adapters and/or output adapters for projects executing on the CEP processing node. Input adapters translate streaming input data 210 from external sources into a CEP data format compatible with the CEP processing node 101a-101c. After an input adapter translates the input data 210 into the CEP data format, projects executing on a CEP processing node 101a-101c may process the input data. Input adapters may be configured to translate input data 210 from many different formats into CEP data format.

Output adapters translate CEP data processed by a CEP processing node 101a-101c from CEP data format to output data 220. Output data 220 may be in a format compatible with external sources and applications. For example, output data 220 may be provided in a format compatible with a database 230 or message bus. Output data 220 may also be in a format that can be transmitted as an electronic mail message, or in a format that can be displayed on a web page dashboard.

CEP cluster 201 may further include CEP cluster nodes 101d-101e configured as

CEP cluster managers, which may monitor CEP processing nodes 101a-101c. CEP cluster managers 101d-101e may be configured to control which CEP processing node or nodes 101a-101c perform statement processing. Further, CEP cluster managers 101d-101e may be configured to perform load balancing actions, as described herein. CEP cluster managers 101d-101e may also be configured to start, stop, move, or otherwise modify projects executing on CEP processing nodes 101a-101c.

CEP cluster 201 may further include a CEP cluster node 101f configured as a CEP load balancing agent. CEP load balancing agent 101f may aggregate statistics for one or more CEP processing nodes 101a-101c, or one or more projects executing on CEP processing nodes 101a-101c. CEP load balancing agent 101f may also operate in conjunction with CEP cluster managers 101d-101e to perform load balancing actions.

Although CEP cluster nodes 101a-101f are described as individually functioning as CEP processing nodes, CEP cluster managers, or CEP load balancing agents, a CEP cluster node 101 may operate as any of a CEP processing node, CEP cluster manager, or a CEP load balancing agent, and may operate as any combination of the three.

In an embodiment, CEP processing nodes 101a-101c process CEP data as objects that may be, but are not limited to, data streams and windows. Data streams are basic components for transmitting streaming data within processing nodes 101a-101c. CEP processing nodes 101a-101c receive input data 210. Input adapters may be configured to convert input data 210 into CEP data in the form of CEP data streams. CEP processing nodes 101a-101c execute CCL statements on the CEP data streams. CCL statements may be included in projects executing on each CEP processing node 101a-101c. CEP processing nodes 101a-101c may then transform the executed CEP data into another CEP data stream that may be processed using other CCL statements, or transformed using an output adapter, until the data is output as output data 220.

Windows are collections of rows that include data from the CEP data streams. Windows may be similar to database tables. In an embodiment, CEP processing nodes 101a-101c may aggregate at least some CEP data included in one or more data streams across one or more windows. CCL statements may be executed on CEP data aggregated in a window. Windows may aggregate CEP data over a particular amount of time.

In an embodiment, CEP processing nodes 101a-101c operate on data streams and windows using CCL statements. CCL statements are instructions that use CEP data from one or more streaming data streams as input. CCL statements analyze and manipulate CEP data using logic configured by an application developer and generate an output which may be another CEP data stream or window. CCL statements execute continuously by a CEP processing node 101a-101c. For example, each time real-time data arrives at a CEP processing node 101a, CEP processing node 101a may execute a CCL statement on the received data.

One or more CCL statements may be combined into a project. Projects may use CCL statements executing against streaming data to perform various analytic tasks, such as detecting patterns in streaming data.

Firms using CEP systems may execute projects or other instructions against data received by the CEP system. Such projects are of varying priority and response time requirements. For example, projects which execute stock trades on the basis of analyzed information may be of very high priority, while ongoing analysis that may not be acted upon for a number of seconds or minutes, or data collection used for archiving purposes, may be of lower priority. Further, certain projects may consume more resources than other projects.

Depending on the incoming message rate, the complexity of the project, latency requirements, and other statistics, one project executing in a CEP cluster may require more hardware resources than another. Thus, identifying a project that requires more hardware resources, and identifying a node in a cluster with more capacity, may allow the project to move to such a node and perform according to desired characteristics.

For each CEP processing node in a CEP cluster 201, various statistics and characteristics may be collected to determine the suitability of the processing node for load balancing purposes. Such information may be gathered when a node joins a CEP cluster. Static statistics may include, but is not limited to, the clock rate or speed of a processor 110 of a node, the amount memory 120 of a node, or other temporary memory included in the node, and the amount of storage 130 of a node. Other static statistics of a node may include the operating system, the CPU architecture of a processor, the number of cores of a processor, a geographic location, a network interface speed, a network interface type, a graphics processing unit type, a graphics processing unit speed, a storage type, a storage speed, and a user configured capacity. A user configured capacity may be a number set by a user to indicate which projects may execute on a node, based on the cost of a project. In one embodiment, static statistics are collected by a CEP cluster manager or a CEP load balancing agent.

Further, for each CEP processing node in the CEP cluster, dynamic statistics, which may change over time, may be monitored and collected periodically. For example, the load or utilization of the processor 110 may be monitored. Further, the amount of RAM or memory 120 currently being used on the node may be monitored. Input and output rates for both storage 130 and the network interface 140 of the node may also be collected, along with the number of threads executing on the node and the available disk space. Dynamic statistics, such as processor utilization or memory usage, may be collected per thread, per project, per server process, per user, or per node. Similarly, the number of threads may be collected per project, per server process, or per node. Dynamic statistics may be collected periodically, for example, at every second, ten seconds, or at any other time interval.

The status of individual projects executing on a node may also be collected. Such statistics may be related to the messages processed by a project, and may be aggregated across all projects for the node. For example, the number of input, output, or pending stream messages for the project may be used. The latency requirement of each project may also be collected. Such a latency requirement may be set by a user. A latency statistic may be collected per CCL path, per input or output adapter, or per project. Additionally, for latency, a user may configure over what time period latency statistics should be collected. For example, the maximum latency over the previous five minutes, or the average latency for the project may be collected. Further, the CPU usage of a process for the project, the project itself, or a thread for the project may be collected. The memory usage of the project or process of the project may be collected. For projects which require persistence, the disk usage of the project may be monitored. Project statistics may also be collected periodically, for example, at every second, ten seconds, or at any other time interval. Other statistics of individual projects may include user specified costs for a project or for moving a project, an input or output throughput rate, and an aggregated input or output throughput amount. Further, for each project, adapter specific metrics, such as the number of database transactions for a database output adapter, may be collected. For each dynamic statistic that is collected, a user may specify a desired range that can be used to identify when a load balancing agent should cause a load balancing action to be taken.

In one embodiment, dynamic statistics are collected by a load balancing agent.

For example, a load balancing agent such as CEP load balancing agent 101f may collect dynamic statistics. A load balancing agent may also collect static statistics. In one embodiment, a load balancing agent may be included on each CEP processing node 101a-101c and may be implemented, in one embodiment, by a processor 110 of a CEP node 101. In a further embodiment, a CEP cluster manager 101d-101e may also be configured as a CEP load balancing agent 101f that collects statistics from each CEP processing node 101 in the cluster.

Based on the statistics collected by a CEP load balancing agent, a load balancing action may be taken. For dynamic statistics and project statistics, thresholds may be specified by a user. Such thresholds may be used to determine whether a load balancing action should be taken. Load balancing actions may include, but are not limited to, redistributing projects from an unhealthy node to a healthy node, providing greater resources to a project, or moving a project from a node to another node having higher capacity. Such load balancing actions may be performed, in one embodiment, by a CEP cluster manager 101d-101e of a CEP cluster 201.

### Method

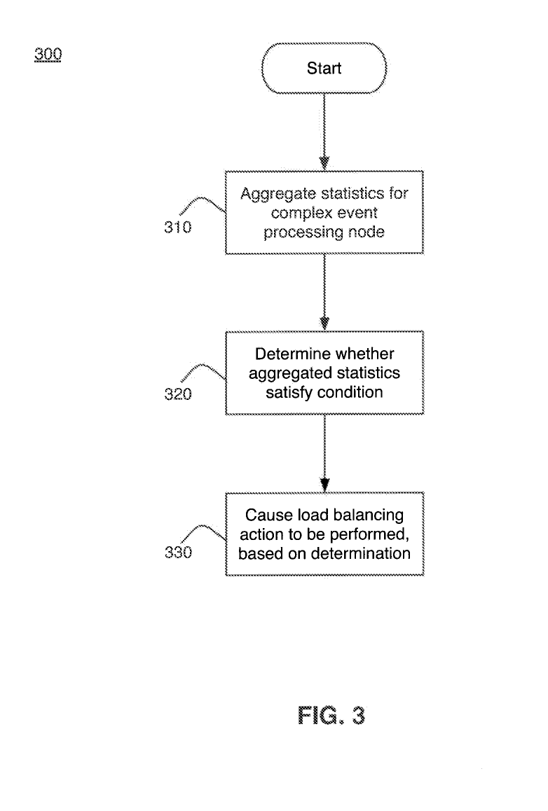

FIG. 3 is a flow diagram of a method 300 in accordance with an embodiment. In one embodiment, method 300 may be performed by a load balancing agent implemented on a CEP node 101. In a further embodiment, method 300 may be performed by a CEP cluster manager.

At stage 310, statistics are aggregated for a complex event processing node. Statistics may be collected, in one embodiment, by a CEP load balancing agent 101f or a CEP cluster manager 101d-101e. Aggregated statistics may include static statistics of the complex event processing node collected when the node joins a cluster. Static statistics refer to characteristics or statistics of an event processing node which do not change over time. Aggregated statistics may also include dynamic statistics of the complex event processing node collected periodically, for example, as a data stream or window. Dynamic statistics refer to statistics that may change over time, such as CPU usage. Further, aggregated statistics may include statistics for projects executing on the complex event processing node. Such statistics for projects may also be collected as a data stream or window as described above.

At stage 320, based on the aggregated statistics, a determination is made as to whether the aggregated statistics satisfy a condition. In an embodiment, a CEP load balancing agent 101f may perform stage 320. Conditions may be specified by one or more heuristics or rules, as will be further explained below. Such conditions may be provided by a manufacturer of a CEP node of cluster manager. Further, conditions may be modified and specified by a user of a CEP system.

At stage 330, based on the determination at stage 320, a load balancing action may be performed. Various load balancing actions may be possible and are not limited to the examples included herein. In one embodiment, a CEP load balancing agent 101f may instruct a CEP cluster manager 101d-101e to perform a load balancing action. In one embodiment, if cluster managers are implemented on each node in a cluster, the cluster manager of a specific CEP node may perform the load balancing action, or cause another CEP node to perform the load balancing action.

### Load Balancing Actions

As specified above with reference to stage 330, based on the collected information, a load balancing action may be taken. For example, one load balancing action may include redistributing projects executing on nodes identified as unhealthy. A determination in accordance with stage 320 may take into account various collected statistics. For example, an unhealthy node may be characterized by a node having a hardware issue, or a node executing an instance of a process or project which is monopolizing the resources of the node. Symptoms characterizing an unhealthy node may include system load metrics (such as CPU utilization or memory usage) which repeatedly exceed specified thresholds within a given period of time, while message rates remain within typical boundaries without significant increases.

Another example load balancing action may include providing greater resources to a high-load or high-priority project. Greater resources may be provided by pausing lower priority projects, or moving lower priority projects to a different node. Similarly, greater resources may be provided by increasing thread priority for a project. For example, upon detecting a high data rate for the project, in accordance with stage 320, and determining that the high priority project is under stress, also in accordance with stage 320, the load balancing action may be taken. Symptoms of such a situation may include an input message rate which repeatedly exceeds an allowed threshold over a period of time. Further, the pending message count for the project may exceed a given threshold, or may be growing at a high rate. If the node for the project is running at or near full capacity, and other projects on the node have a lower priority or data rate, the load balancing action may be taken.

A further load balancing action taken in accordance with stage 330 may include moving a project to a node having higher capacity. Such a load balancing action may only be taken if moving a project is permitted by the user of the project. Further, the project to be moved may be a project which is not high priority. The heuristic may also require that other nodes in the cluster have sufficient available capacity to accommodate the project at its current data rate. For example, if the input message rate for a project exceeds an allowed threshold for a given amount of time, as determined in accordance with stage 320, the project may be moved to a different node. Further, if the pending message count for the node exceeds a given threshold, or is growing at a high rate, also as determined in accordance with stage 320, the project may be moved to a different node. Further, if the node's pending database or remote procedure call message count exceeds a given threshold, also as determined in accordance with stage 320, the project may be moved to a different node.

In one embodiment, load balancing actions in accordance with stage 330 may be performed to ensure that no one node of a CEP cluster is overburdened. Load balancing actions may have the effect of increasing performance for an entire cluster, such that projects can process incoming data at a high rate to meet latency requirements in a CEP system.

### Further Details

In one embodiment, heuristics may be used to determine whether statistics satisfy a condition in accordance with stage 320, and thus whether to take a load balancing action in accordance with stage 330. In some implementations, heuristics may be coded in CCL. Statistics may be aggregated and collected as a real-time data stream or window in accordance with stage 310, and a CCL statement may be executed against the real-time data in accordance with stage 320, to determine whether a condition is met. In one embodiment, coded heuristics may ignore normal load spikes, and cause load balancing actions to be taken only when absolutely necessary. In a further embodiment, coded heuristics may include CCL logic that causes the load balancing action to be performed. In yet a further embodiment, different projects executing on a CEP cluster may be assigned different load balancing heuristics.

To define heuristics, performance metrics may be aggregated over a particular amount of time, as described with reference to stage 310. Statistical calculations may be used to trigger a load balancing action when a given metric exceeds normal operating boundaries over a configurable period of time. Thus, for example, if CPU usage for a node exceeds normal operating boundaries once, no load balancing action may be taken. Conversely, if CPU usage repeatedly exceeds normal operating boundaries over a certain time period, such as ten seconds, a load balancing action may be taken to redistribute projects.

In one embodiment, projects that can be assigned a higher or lower priority may be specified by a user. By default, all projects may be set to the same priority. User hints may assist in determining whether a project is non-critical, and correspondingly, those projects may have their priority adjusted.

In one embodiment, each CEP processing node may be assigned a penalty based on a function of time. The penalty may reflect the willingness of a node to accept a delay due to a load balancing action at a particular point in time. The cost of moving a project may also be taken into account for a particular load balancing action. Similarly, a CEP processing node may indicate a benefit as a function of time and resources. A load balancing action may be taken if the benefit outweighs the penalty or cost. Further, a penalty of infinity may indicate that a project should not be balanced at that time.

In one embodiment, a load balancing agent may use statistical methods to predict future statistics. For example, the load balancing agent may recognize patterns over time. Thus, for example, a particular processing node may be identified to be active every day from 9 AM to 5 PM. The load balancing agent may use this information in making load balancing decisions.

As described above, load balancing actions may be performed in accordance with stage 330 on the basis of data streams. Thus, load balancing may be implemented as a project, which may receive real-time data streams that contain static statistics, dynamic statistics, and project statistics, in accordance with stage 310. In one embodiment, load balancing projects executing on a CEP cluster may be assigned a higher priority than other projects.

In one embodiment, the affinity of multiple projects may be considered when determining whether to perform a load balancing action. For example, two projects may be highly related, and moving one project to another node may greatly affect the performance of both projects. Accordingly, a load balancing action may only be taken for both projects together, not either project individually.

In one embodiment, a determination to perform a load balancing decision is considered on a cluster-wide basis. Thus, the determination, may be a global optimization problem. A load balancing action may only be performed if the benefits across the CEP cluster outweigh the costs across the CEP cluster.

In one embodiment, the cost of moving a project may be a one-time cost.

Conversely, the benefit of moving a project may vary over time. Thus, a decision to perform a load balancing action may need to consider when the balancing action is taken. For example, a load balancing action may be performed proactively when the cost of moving a project is low, in anticipation of future benefits of the load balancing action.

In one embodiment, a CEP cluster manager may consider whether to take a load balancing action when a CEP processing node is added or removed from a CEP cluster.

### Computer System

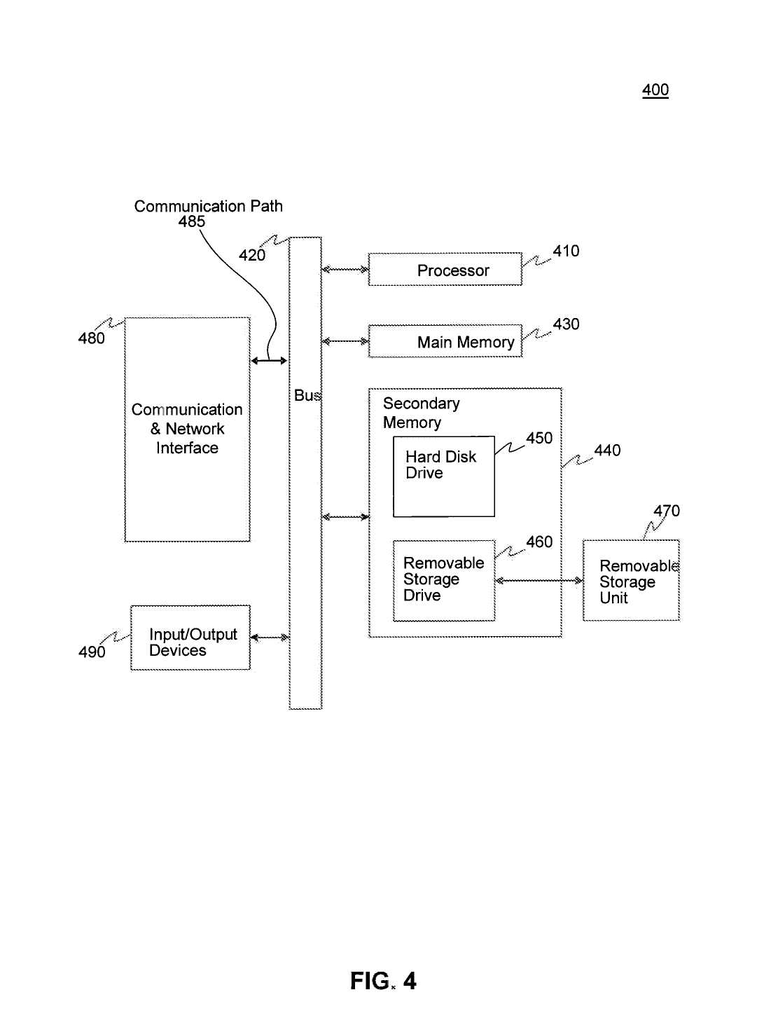

Various aspects of the invention can be implemented by software, firmware, hardware, or a combination thereof. FIG. 4 illustrates an example computer system 400 in which the invention, or portions thereof, can be implemented as computer-readable code. For example, the methods illustrated by flowcharts described herein can be implemented in system 400. Various embodiments of the invention are described in terms of this example computer system 400. For example, each CEP node 101 may include one or more computer systems 400. After reading this description, it will become apparent to a person skilled in the relevant art how to implement the invention using other computer systems and/or computer architectures.

Computer system 400 includes one or more processors, such as processor 410. Processor 410 can be a special purpose or a general purpose processor. Processor 410 is connected to a communication infrastructure 420 (for example, a bus or network).

Computer system 400 also includes a main memory 430, preferably random access memory (RAM), and may also include a secondary memory 440. Secondary memory 440 may include, for example, a hard disk drive 450, a removable storage drive 460, and/or a memory stick. Removable storage drive 460 may comprise a floppy disk drive, a magnetic tape drive, an optical disk drive, a flash memory, or the like. The removable storage drive 460 reads from and/or writes to a removable storage unit 470 in a well-known manner. Removable storage unit 470 may comprise a floppy disk, magnetic tape, optical disk, etc. which is read by and written to by removable storage drive 460. As will be appreciated by persons skilled in the relevant art(s), removable storage unit 470 includes a computer usable storage medium having stored therein computer software and/or data.

In alternative implementations, secondary memory 440 may include other similar means for allowing computer programs or other instructions to be loaded into computer system 400. Such means may include, for example, a removable storage unit 470 and an interface (not shown). Examples of such means may include a program cartridge and cartridge interface (such as that found in video game devices), a removable memory chip (such as an EPROM, or PROM) and associated socket, and other removable storage units 470 and interfaces which allow software and data to be transferred from the removable storage unit 470 to computer system 400.

Computer system 400 may also include a communications and network interface 480. Communications interface 480 allows software and data to be transferred between computer system 400 and external devices. Communications interface 480 may include a modem, a communications port, a PCMCIA slot and card, or the like. Software and data transferred via communications interface 480 are in the form of signals which may be electronic, electromagnetic, optical, or other signals capable of being received by communications interface 480. These signals are provided to communications interface 480 via a communications path 485. Communications path 485 carries signals and may be implemented using wire or cable, fiber optics, a phone line, a cellular phone link, an RF link or other communications channels.

The network interface 480 allows the computer system 400 to communicate over communication networks or mediums such as LANs, WANs the Internet, etc. The network interface 480 may interface with remote sites or networks via wired or wireless connections.

In this document, the terms “computer program medium” and “computer usable medium” and “computer readable medium” are used to generally refer to media such as removable storage unit 470, removable storage drive 460, and a hard disk installed in hard disk drive 450. Signals carried over communications path 485 can also embody the logic described herein. Computer program medium and computer usable medium can also refer to memories, such as main memory 430 and secondary memory 440, which can be memory semiconductors (e.g. DRAMs, etc.). These computer program products are means for providing software to computer system 400.

Computer programs (also called computer control logic) are stored in main memory 430 and/or secondary memory 440. Computer programs may also be received via communications interface 480. Such computer programs, when executed, enable computer system 400 to implement embodiments of the invention as discussed herein. In particular, the computer programs, when executed, enable processor 440 to implement the processes of the invention, such as the steps in the methods illustrated by flowcharts discussed above. Accordingly, such computer programs represent controllers of the computer system 400. Where the invention is implemented using software, the software may be stored in a computer program product and loaded into computer system 400 using removable storage drive 460, interfaces, hard drive 450 or communications interface 480, for example.

The computer system 400 may also include input/output/display devices 490, such as keyboards, monitors, pointing devices, etc.

The invention is also directed to computer program products comprising software stored on any computer useable medium. Such software, when executed in one or more data processing device(s), causes a data processing device(s) to operate as described herein. Embodiments of the invention employ any computer useable or readable medium, known now or in the future. Examples of computer useable mediums include, but are not limited to primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

The invention can work with software, hardware, and/or operating system implementations other than those described herein. Any software, hardware, and operating system implementations suitable for performing the functions described herein can be used.

### CONCLUSION

It is to be appreciated that the Detailed Description section, and not the Summary and Abstract sections, is intended to be used to interpret the claims. The Summary and Abstract sections may set forth one or more but not all exemplary embodiments of the invention as contemplated by the inventor(s), and thus, are not intended to limit the invention and the appended claims in any way.

The invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the specification is to be interpreted by the skilled artisan in light of the teachings and guidance.

The breadth and scope of the invention should not be limited by any of the above-described exemplary embodiments, but should be defined only in accordance with the following claims and their equivalents.

What is claimed is:

1. A computer-implemented method in a complex event processing cluster manager, comprising:
aggregating one or more static statistics of a complex event processing node, one or more dynamic statistics of the complex event processing node, and one or more project statistics for one or more projects executing on the complex event processing node;
determining whether the aggregated statistics satisfy a condition; and
causing a load balancing action to be performed, based on the determination.

2. The method of claim 1, wherein the static statistics of the complex event processing node include one or more of a CPU clock rate, a memory amount, a disk space amount, an operating system, a CPU architecture, a number of cores, a geographic location, a network interface speed, a network interface type, a graphics processing unit type, a graphics processing unit speed, a storage type, a storage speed, and a user configured capacity.

3. The method of claim 1, wherein the one or more dynamic statistics of the complex event processing node include one or more of a CPU utilization percentage, a memory usage amount, a memory usage percentage, a number of threads amount, a disk input rate, a disk output rate, a network input rate, a network output rate, and an available disk space amount.

4. The method of claim 1, wherein the one or more project statistics for one or more projects executing on the complex event processing node include one or more of an input stream message rate, an output stream message rate, a pending stream message rate, a latency statistic, a CPU utilization amount, a memory usage amount, a user specified cost, an input throughput rate, an output throughput rate, an aggregated input throughput amount, an aggegated output throughput amount, an adapter specific performance metric, or a disk usage amount.

5. The method of claim 1, wherein causing a load balancing action to be performed further comprises increasing the priority of a project executing on the complex event processing node, based on the determination.

6. The method of claim 1, wherein causing a load balancing action to be performed further comprises moving a project executing on the complex event processing node to a second complex event processing node, based on the determination.

7. The method of claim 1, wherein causing a load balancing action to be performed further comprises providing more resources to a project executing on the complex event node, based on the determination.

8. The method of claim 1, wherein determining whether the aggregated statistics satisfy a condition further comprises determining whether a CPU utilization percentage of the complex event processing node satisfies a threshold.

9. The method of claim 1, wherein determining whether the aggregated statistics satisfy a condition further comprises determining whether a input stream message rate of the complex event processing node satisfies a threshold.

10. The method of claim 1, wherein determining whether the aggregated statistics satisfy a condition further comprises determining whether a pending message count of the complex event processing node satisfies a threshold.

11. The method of claim 1, wherein determining whether the aggregated statistics satisfy a condition further comprises determining whether a dynamic statistic of the complex event processing node satisfies a user-specified threshold.

12. A complex event processing node, comprising:
a load balancing agent, configured to:
aggregate one or more static statistics of a complex event processing node, one or more dynamic statistics of the complex event processing node, and one or more project statistics for one or more projects executing on the complex event processing node;
determine whether the aggregated statistics satisfy a condition; and
cause a load balancing action to be performed, based on the determination.

13. The system of claim 12, wherein the static statistics of the complex event processing node include one or more of a CPU clock rate, a memory amount, a disk space amount, an operating system, a CPU architecture, a number of cores, a geographic location, a network interface speed, a network interface type, a graphics processing unit type, a graphics processing unit speed, a storage type, a storage speed, and a user configured capacity.

14. The system of claim 12, wherein the one or more dynamic statistics of the complex event processing node include one or more of a CPU utilization percentage, a memory usage amount, a memory usage percentage, a number of threads amount, a disk input rate, a disk output rate, a network input rate, a network output rate, and an available disk space amount.

15. The system of claim 12, wherein the one or more project statistics for one or more projects executing on the complex event processing node include one or more of an input stream message rate, and output stream message rate, a latency statistic, a CPU utilization amount, a memory usage amount, a user specified cost, an input throughput rate, an output throughput rate, an aggregated input throughput amount, an aggregated output throughput amount, an adapter specific performance metric, or a disk usage amount.

16. The system of claim 12, wherein the cluster manager is further configured to cause a load balancing action to be performed by increasing the priority of a project executing on the complex event processing node, based on the determination.

17. The system of claim 12, wherein the cluster manager is further configured to cause a load balancing action to be performed by moving a project executing on the complex event processing node to a second complex event processing node, based on the determination.

18. The system of claim 12, wherein the cluster manager is further configured to cause a load balancing action to be performed by providing more resources to a project executing on the complex event node, based on the determination.

19. A computer readable storage medium having instructions stored thereon that, when executed by a processor, cause the processor to perform operations comprising:
aggregating one or more static statistics of the complex event processing node, one or more dynamic statistics of the complex event processing node, and one or more project statistics for one or more projects executing on the complex event processing node;
determining whether the aggregated statistics satisfy a condition; and
causing a load balancing action to be performed, based on the determination.

20. The computer readable storage medium of claim 19, wherein causing a load balancing action to be performed further comprises increasing the priority of a project executing on the complex event processing node, based on the determination.
